(19) United States
(12) Patent Application Publication
(10) Pub. No.: US 2009/0188434 A1
(43) Pub. Date: Jul. 30, 2009

(54) Disposable hummingbird feeder

(75) Inventor: Joseph E. McMullen, Greenville, SC (US)

Correspondence Address: NATRIUM, LLC, 9 FISHER ROAD, GREENVILLE, SC, 29615, US

(73) Assignee: NATRIUM, LLC.

(21) Appl. No.: 12/011,066

(22) Filed: Jan. 24, 2008

(51) Int. Cl. A01K 5/00

(52) U.S. Cl. 119/72

(57) ABSTRACT

The present invention combines a classical hummingbird feeder with the disposable features that make it safe and easy to use. A transparent cylindrical fluid reservoir contains a feeding solution that is dispensed through a feeding tube assembly at the bottom of the reservoir. The feeding tube assembly is attached to a bottom disc that is supported and sealed at the bottom of the cylindrical fluid reservoir by a red bottom cap threaded to the reservoir. The red feeding tube assembly has an exit tube that can be adjusted to place an exit aperture in an optimum location for the hovering hummingbird. Single or multiple exit tubes can be provided. The feeding solution has an additive to determine when it has spoiled. The top of the fluid reservoir has a moat filled with an insect inhibiting fluid to protect against insects and ants. A red label is placed on the reservoir to provide logo, directions for use and safety warnings thereon.

### BACKGROUND OF THE INVENTION

This invention is directed to hummingbird feeder and more particularly to an economical feeder design so that it can be discarded after use. In particular, the feeder has only essential parts that can be easily produced to provide the necessary components to be an effective and safe feeder for one or more hummingbirds.

The most commonly used hummingbird feeders are configured to have a top reservoir portion containing a nectar coupled to a bottom portion having a feeding region for the hummingbird to access the nectar.

For most feeders a problem exists as a result of the use of high sugar content in the nectar or feeding solution. The feeding solution spoils and becomes contaminated within a relatively short period of time. In hot weather this can be as short as two days. Spoilage results in the accumulation of mold slime and the sugar turns to alcohol. The results of the chemical reaction and contamination of the feeding solution endangers the health of the birds being fed. Feeders can also present health risks to humans. Cleaning of the feeder is a multi-step process and must be frequent to maintain a desirable and safe level of performance. Adequate cleaning is difficult for several reasons requiring the use of a variety of brushes to clean the interior. For example, the feeding ports are very small to accommodate the beak of a hummingbird; having an opening of about one-eighth of an inch. Proper cleaning is critical for reusing the feeder. In addition, the preparation of the nectar should be done with utmost care before the feeder can be returned to service. The proper mixture ratios and attention to the risk of contamination are critical.

A further contamination of many conventional hummingbird feeders results from ants and other crawling insects. The ants and insects travel down the hangar portion to reach the top reservoir and feeding region. In tests, conventional hummingbird feeders were found to require frequent cleaning in order to remove accumulated ants or insects.

Therefore, the process of cleaning hummingbird feeders is time consuming, messy and unsanitary process that detracts from the enjoyment of feeding hummingbirds. This deters many from continuing to use their feeders and many users simply refill the hummingbird feeder with a fresh feeding solution, while foregoing the cleaning process. It has become a popular pastime of adults and children to feed and watch hummingbirds at a feeder. It also serves a purpose of providing necessary food for the birds. If the dangers associated with simply refilling the feeder were known, this t may be directed inward or outward

These commonly used hummingbird feeders typical of the industry are disclosed in U.S. Pat. Nos. 7,234,418; 7,093,562; 5,740,759; 5,507,249; 5,450,816; 5,269,258; 4,968,168; 4,901,673; 4,558,662; D544,651; D542,459; D54,749; D454,669; and 2007/0006813. The '418 patent discloses a hummingbird feeder which can be taken apart for easier maintenance. The '816 patent discloses an easy to fill reservoir that prevents spoilage of the sugar solution by making the reservoir as small as possible to provide at most, one to two days supply of the feeding solution. The “673 patent discloses an upward opening receptacle at the top of the reservoir filled with an insect inhibiting fluid to provide an effective barrier for ants and insects from reaching the feeding solution. The '562 patent and the '6813 patent application by Smothers discloses various means to lock a feeding assembly to the reservoir to help prevent refilling without damaging the feeding assembly. The '759 patent discloses a feeding tube that may be directed inward or outward of a container. However, two discs are required to seal the opening and the feeding tube has a fixed angle extending downward. None of these patents disclose a disposable hummingbird feeder having an economical and contamination free design with adjustable angled feeding tubes of the present invention.

The need remains to clearly inform the user of the danger to the hummingbird in reusing a hummingbird feeder. A simple low cost design of the feeder is critical so that the user has no problem in disposing of the used feeder and replacing it with another one. In addition, the feeding solution can spoil and become contaminated prior to being consumed. No indication of a safe-to-use feeding indicator for the feeding solution was found in the art. Protection against contamination of the all components of the hummingbird feeder during storage and distribution of the feeder should also be provided. Additional consideration was given in the present invention to the fact that the hummingbird has a long slender beak and remains in a hovering motion while feeding. The angle of the feeding tube should also be made to be adjustable. The hummingbirds have also been observed to feed one at a time with the dominant hummingbird keeping the others away. Therefore, the use of a perch and more than one feeding port, commonly found in the art, is not required but may be added to allow closer observation of the hummingbird. These needs remain unfulfilled.

Inasmuch as the art is relatively crowded with respect to hummingbird feeders, it can be appreciated that there is a continuing need for and interest in improvements to such hummingbird feeders. In this respect, the present invention addresses this need and interest.

Accordingly, it is the objective an object of the present invention is to provide a hummingbird feeder with a simple and rugged design that readily attracts hummingbirds, is easily put into service, safe and easy to use and economical to make.

An essential object of the present invention is to provide a hummingbird feeder that is clearly marked to be harmful to hummingbirds if it is refilled to be used again.

Another essential object of the present invention is to provide a hummingbird feeder with a relatively small but sterile volume of feeding solution that can be provided with a safe-for-use indicator or additive.

Another object of the present invention is to provide at least one feeder tube that can be kept sterile prior to use and easily deployed when the feeder is placed into service.

Yet another object of the present invention is to provide a at least one feeder tube that can be adjusted to be placed at optimum horizontal and vertical angles for the hummingbird to feed.

One additional object of the present invention is to provide a means to protect the feeding solution from contamination by ants and other insects.

A further object of the present invention is to provide the user with the convenience of a single use feeder, thus eliminating the cleaning and solution preparation tasks.

### SUMMARY OF THE INVENTION

The present invention combines a classical hummingbird feeder with the disposable features that make it safe and easy to use. A transparent fluid reservoir contains a feeding solution that is dispensed through a feeding tube assembly at the bottom of the reservoir. The feeding tube assembly is attached to a bottom disc that is supported and sealed at the cylindrical bottom of the fluid reservoir by a bottom cap threaded to the reservoir. The feeding tube assembly has an exit tube that can be rotated and angled to place an exit aperture in an optimum location for the hovering hummingbird to feed. A single or multiple feeding tubes can be provided. The feeding solution is added prior to the point-of-sale and has an additive to determine when it has spoiled. The top of the fluid reservoir has a moat that can be filled with an insect inhibiting fluid or gel to protect against insects and ants reaching the feeding solution. A label is placed on the reservoir to provide logo, legally mandated information, directions for use, essential safety and contamination warnings, assembly instructions and red coloring to attract the hummingbirds.

The above objectives are accomplished according to the present invention by providing a disposable hummingbird feeder. The feeder comprises a transparent fluid reservoir filled with a feeding solution. The feeder has a closed and recessed top and an open cylindrical bottom portion with threads. A bottom cap has cap threads that mesh with the threads of the fluid reservoir. A bottom disc is carried by the bottom cap to be friction sealed against a bottom edge of the fluid reservoir to help retain the feeding solution. A feeding tube assembly is connected to a center of the bottom disc to provide an exit aperture for the hummingbird to access the feeding solution. The bottom disk and feeding tube assembly have a first sealed storage position where the feeding tube assembly extends upward into the fluid reservoir and a second inverted feeding position where the feeder tube extends downward to be accessed by the hummingbird. The feeding tube assembly includes at least one exit tube which is rotationally adjustable both vertically and horizontally for optimum access by the hummingbird to the exit aperture and for viewing.

In one aspect of the invention the feeding tube assembly further comprises a tube adaptor for connecting a main tube to the bottom disc to extend downward from the bottom disc to a tube flex portion connected to the exit tube. The flex tube portion provides the vertical rotation of the exit tube for the hummingbird to have an optimum hovering angle when accessing the exit aperture. The disc and feeding tube assembly are rotated about a vertical axis with respect to the fluid reservoir for optimum horizontal access to said exit aperture by the hummingbird.

In an alternate aspect of the invention the feeding tube assembly is made integral with the bottom disc and includes a snip-off end of the exit tube to access the exit aperture.

In yet another aspect of the invention a modified bottom cap is made integral with the bottom disc and includes upper and lower threaded portions so that the bottom cap and disk are both inverted, along with the feeding tube assembly, to convert the feeder from the first storage position to the second feeder position.

In a further aspect of the invention the recessed top portion of the cylindrical reservoir includes a hangar tab with an aperture to receive a hangar to hang the hummingbird feeder in an optimum location. The recessed top portion also provides a moat to receive an insect inhibiting fluid to form a barrier against insects reaching the feeding solution.

In yet another aspect of the invention an additive in the form of one or either a coating on the interior surface of the fluid reservoir or a floating object in the fluid reservoir that informs the user that the feeding solution has changed in chemical composition and spoiled, wherein said additive produces a change in the appearance when said feeding solution is no longer safe for consumption by the hummingbird.

In a second embodiment of the invention a disposable hummingbird feeder assembly comprises a transparent cylindrical reservoir filled with a feeding solution. The hummingbird feeder has a closed top portion with a recess and an open bottom portion with a bottom edge. The recess forms a moat with a hangar tab for a hangar and the bottom portion has threads. A bottom cap and disc is threaded to the cylindrical reservoir to help retain the feeding solution within the cylindrical reservoir. A feeding tube assembly is connected to the bottom disc using a tube adaptor to provide an exit aperture for the hummingbird to access the feeding solution. The bottom disk and the feeding tube assembly have a first sealed storage position where the feeding tube assembly extends upward into the fluid reservoir. In a second inverted feeding position the feeding tube assembly extends downward to be accessed by the hummingbird.

In one aspect of the second embodiment a removable thin safety shield is placed over a lower surface of the bottom disc when the bottom disc and feeding tube assembly are in the first sealed storage position, so that the feeding solution is not contaminated when the second inverted feeding position is realized.

In another aspect of the second embodiment the feeding tube assembly includes a main tube connected to said tube adaptor and at least one adjustable exit tube providing at least one exit aperture for feeding the hummingbirds.

In an aspect of the first and second embodiments a bottom disc is sealed against said open bottom edge of said fluid reservoir by an annular flange of the bottom cap. The first and second disc edge sealers provide the seal during both the first storage position and the second feeding position of the bottom disc and feeding tube assembly.

In a further aspect of the first and second embodiments the cylindrical reservoir has a red label applied thereto having general logo, use and safety information printed thereon.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a elevation view of the hummingbird feeder of this invention showing a hummingbird approaching an exit aperture to receive a feeding solution.

FIG. 2 is a cross-sectional view, taken along line 2-2 in FIG. 1, showing a transparent cylindrical reservoir filled with the feeding solution and a bottom disk with a center knockout aperture supported by a bottom cap.

FIG. 3 is a cross-sectional view, taken along line 3-3 in FIG. 1, showing a feeding tube assembly including a main tube and an exit tube connected by a flex tube portion, wherein the feeding tube assembly can be rotated for an optimum feeding location.

FIG. 4A is a cross-sectional view, taken along line 4-4 in FIG. 2, showing the bottom portion of the hummingbird feeder with the feeding tube assembly connected to the bottom disk and extending downward in an inverted feeding position to be accessed by the hummingbird.

FIG. 4B is a cross-sectional view, also taken along line 4-4 in FIG. 2 but modified to show both the bottom and top portions of the hummingbird feeder with the feeding tube assembly connected to the bottom disk and extending upward in an sealed storage position prior to being inverted and used.

FIG. 5A is a cross-sectional view showing the bottom portion of the hummingbird feeder with the bottom cap made integral with the bottom disk and the feeding tube assembly connected to the bottom disk and extending downward in an inverted feeding position to be accessed by the hummingbird.

FIG. 5B is a cross-sectional view showing the bottom portion of the hummingbird feeder with the bottom cap made integral with the bottom disk and the feeding tube assembly connected to the bottom disk and extending upward in an sealed storage position prior to being inverted and used.

FIG. 6A is a perspective view of the thin safety shield being placed on the bottom disk and the feeding tube assembly to keep the top surface of the disc from contaminating the feeding solution during storage and shipping. The location of the first and second disk edge sealers and the tube adaptor are also illustrated.

FIG. 6B is a perspective view of an alternate bottom disk of FIG. 6A being a conical shaped disk for a more complete evacuation of the feeding solution.

FIG. 6C is an exploded perspective view of the thin safety shield the first and second disc edge sealers and another alternate bottom disk made integral with the feeding tube assembly.

FIG. 7A is a cross-sectional view of the center portion of the bottom disc taken along line 7-7 in FIG. 6A showing the bottom disc being connected to the feeding tube assembly using the tube adaptor.

FIG. 7B is an enlarged perspective view of the tube adaptor of FIG. 7A.

FIG. 8A is a perspective view of the feeding tube assembly showing the main tube and three exit tubes connected by an exit adaptor.

FIG. 8B is an enlarged perspective view of the exit adaptor of FIG. 8A.

FIG. 9 is a perspective view of the top portion of the cylindrical reservoir showing the hangar tab, hangar and moat.

FIG. 10 is a perspective view of a number of hummingbird feeders and a mote fluid container in a carrying case.

### DESCRIPTION OF A PREFERRED EMBODIMENT

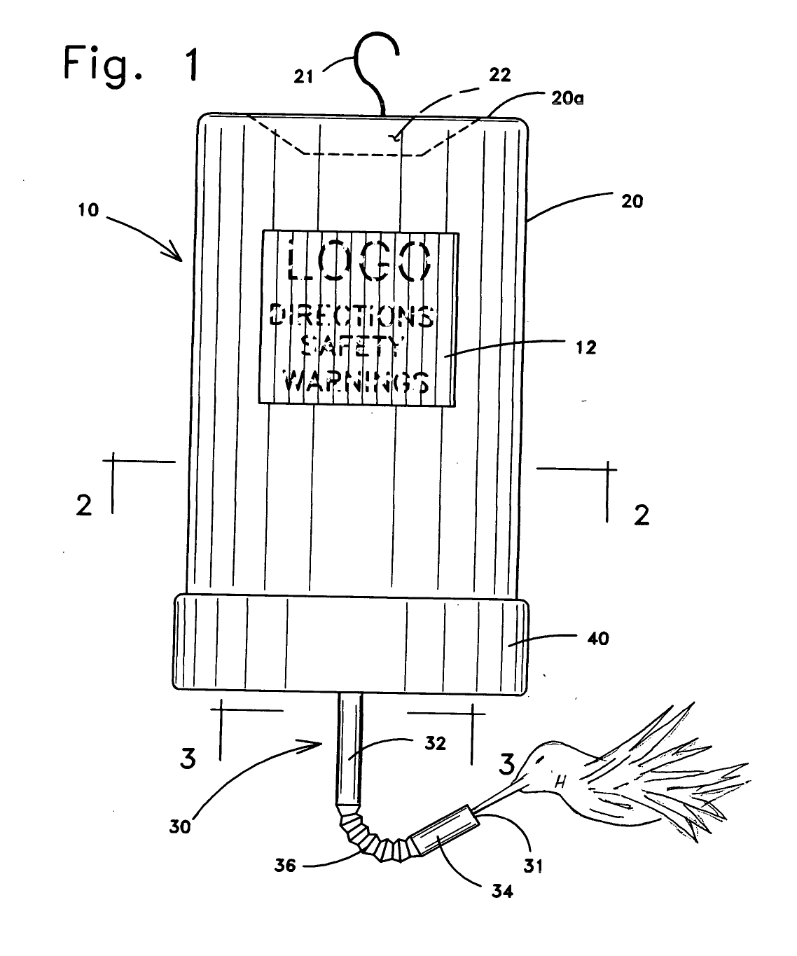

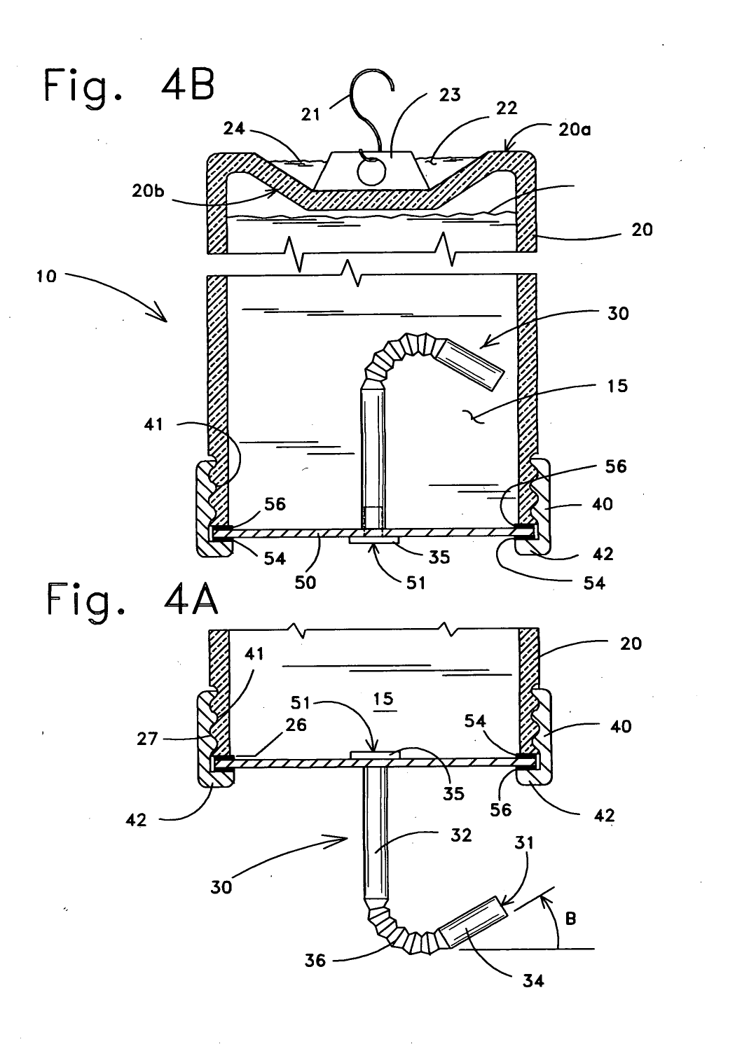

Referring now in more detail to the drawings, the invention will now be described in more detail. An elevation view of a hummingbird feeder 10 in a feeding position according to this invention is illustrated in FIG. 1. A transparent fluid reservoir 20 has a bottom cap 40 with a bottom disc 50 (See FIG. 4) screwed on the reservoir to contain a feeding solution. The feeding solution is accessed by a hummingbird “H” through a feeding tube assembly 30 having an exit aperture 31. The feeding tube assembly has a main tube 32 connected to the bottom disc, a tube flex portion 36 and an exit tube 34. The tube flex portion provides a unique adjustable feeding angle “B” for the hovering hummingbird. A top surface 20a of the fluid reservoir is flat but recessed to provide a moat 22 and to facilitate shipping and handling. The mote will be describe in more detail below. A hangar 21 is provided to support the hummingbird feeder in an appropriate location.

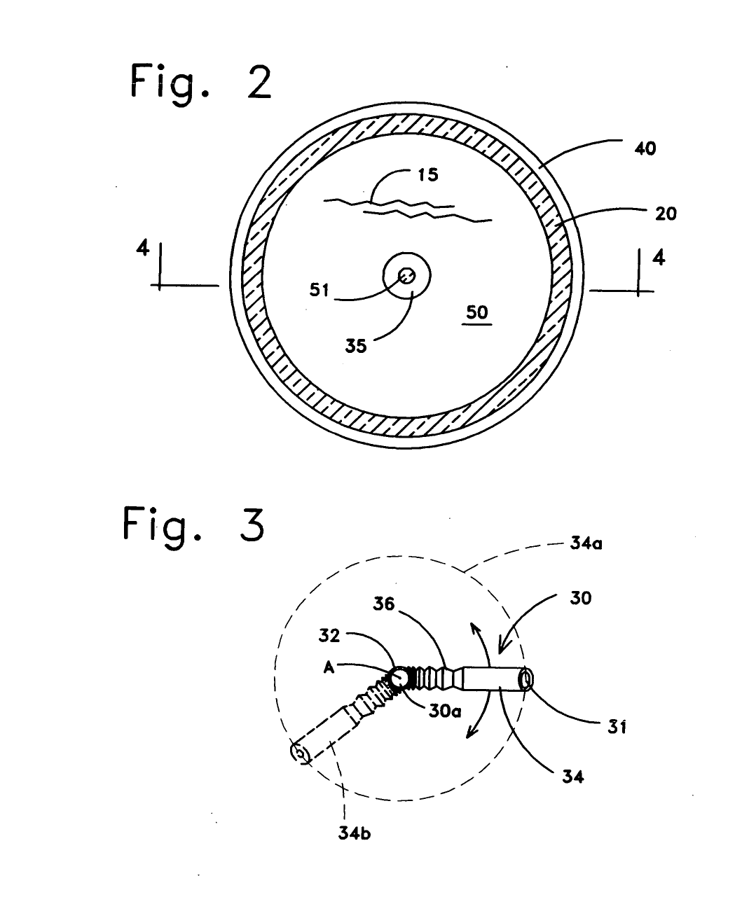

Details of the hummingbird feeder are illustrated in the cross-sectional view of FIG. 2. This view is taken along line 2-2 in FIG. 1 and shows feeding solution 15 within fluid reservoir 20. The preferred shape of the fluid reservoir is cylindrical. Other polygonal shapes including rectangular and square with rounded corners are within the scope of this invention; as long as space is provided for the feeding tube assembly within the reservoir. Cylindrical bottom cap 40 supports bottom disc 50. The bottom cap is about the same size as the reservoir for ease in placing the feeding tube assembly within the reservoir. A tube adaptor 35 penetrates the center of the bottom disc to provide a center knockout aperture 51 as part of the feeding tube assembly. That is, the center portion of the tube adaptor is knocked out when the hummingbird feeder is placed into service. Alternately, the tube adaptor can be attached to the other side of the bottom disc and the knockout aperture located in the bottom disc.

An additional detail of feeding tube assembly 30 is illustrated in the cross-sectional view of FIG. 3. This view is taken along line 3-3 in FIG. 1 and shows main tube 32, tube flex portion 36 and exit tube 34 with center aperture 30a and exit aperture 31 to be accessed by the hummingbird. The feeding tube assembly can be rotated to an optimum location about a vertical axis “A” as indicated by the curved arrows in FIG. 3. The optimum location is selected for the best rotational location of the exit aperture for feeding the hummingbird based on where the hummingbird feeder is hung.

Additional details of hummingbird feeder 10 are shown in the cross-sectional view of FIG. 4A. This view is taken along line 4-4 in FIG. 2 showing bottom disc 50 and feeding tube assembly 30 in a second feeding position with the feeding tube assembly extending downward to be accessed by the hummingbird. Cylindrical fluid reservoir 20 has an open bottom end with threads 27 that mesh with cap threads 41 of bottom cap 40. The bottom cap has an annular flange 42 that holds the bottom disc sealed against a bottom edge 26 of fluid reservoir 20. A first disc edge sealer 54 between bottom edge 26 and bottom disc 50 and a second disc edge sealer 56 between the bottom disc and the annular flange provide the necessary seal to retain feeding solution 15 in the fluid reservoir. Tube adaptor 35 extends through bottom disc 50 to connect to main tube 32 of feeding tube assembly 30. A center knockout aperture 51 is provided in the tube adaptor to allow the feeding solution to reach exit aperture 31. Tube flex portion 36 allows a feeding angle “B” of exit tube 34 to be adjusted for optimum access to exit aperture 31 by the hummingbird. The optimum angle will facilitate the entry of the hummingbird's beak into the exit tube.

Additional details of hummingbird feeder 10 are shown in the cross-sectional view of FIG. 4B. This view is also taken along line 4-4 in FIG. 2 with the bottom disc and feeding tube assembly in the first sealed storage position with the feeding tube assembly extending upward into the feeding solution prior to use. The view also includes the top portion of the cylindrical fluid reservoir. Once again, the bottom cap has an annular flange 42 that holds bottom disc 50 sealed against a bottom edge 26 of fluid reservoir 20. However, the bottom disc and feeding tube assembly have been turned over so that second disc edge sealer 56 is between bottom edge 26 and bottom disc 50 and a first disc edge sealer 54 is between the bottom disc and the annular flange to provide the necessary seal to retain feeding solution 15 in the fluid reservoir. Bottom cap 40 remains threaded to the open bottom portion of the fluid reservoir in this configuration. The hummingbird feeder configuration of this view is converted to the hummingbird feeder configuration of FIG. 4A prior to use. The feeding tube assembly extending into the feeding solution helps to maintain these components from being contaminated prior to use.

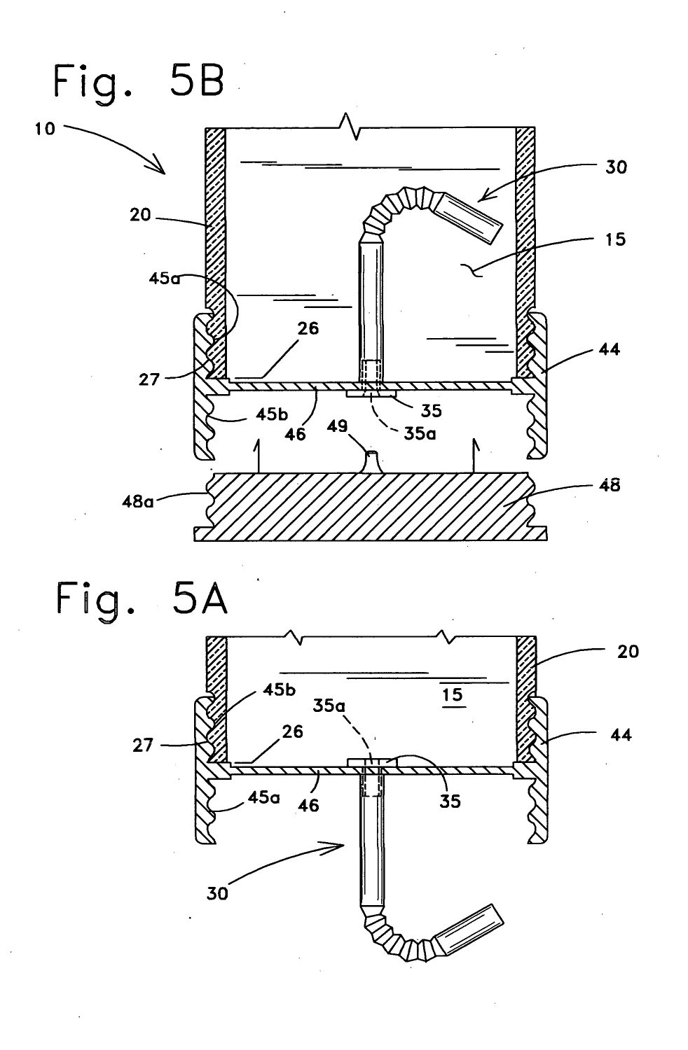

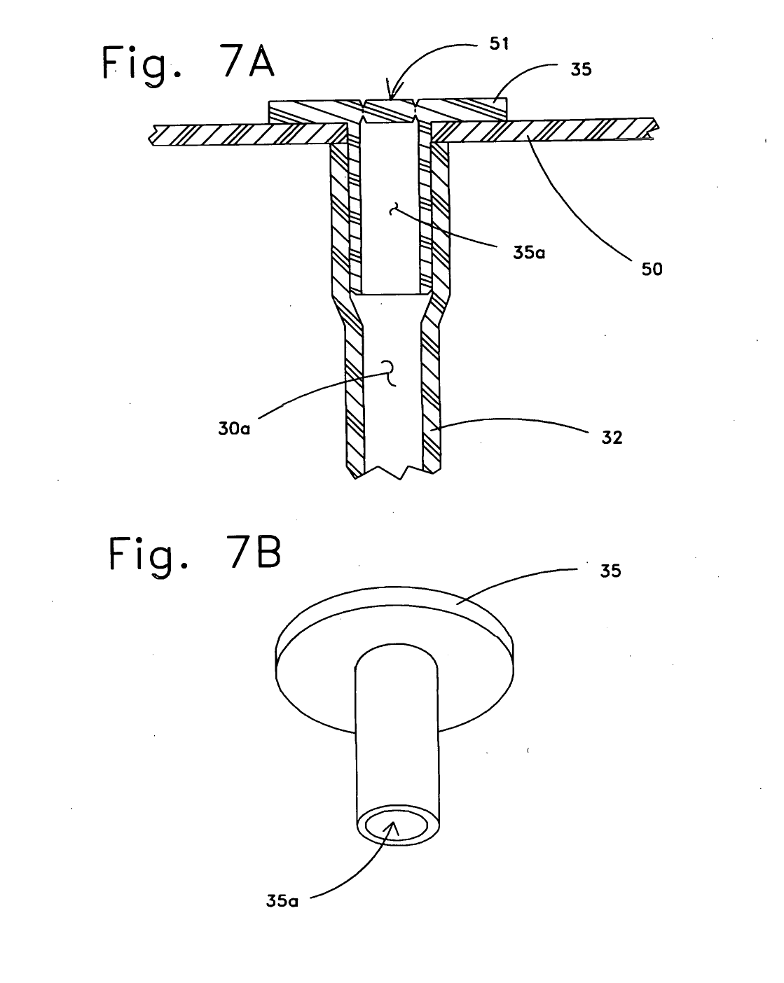

In another aspect of the invention a lid or modified cap 44 is made integral with a modified bottom disc 46 as illustrated in FIG. 5A. The cap has upper threads 45b that mesh with threads 27 of the fluid reservoir as well as lower threads 45a. Therefore, the modified cap is threaded on both sides allowing it to be removed, inverted and reinstalled on the fluid reservoir along with bottom disc 46 and feeding tube assembly 30. This aspect of the invention also allows the feeder to also be stored and shipped with the feeding tube assembly inside the reservoir, as shown in FIG. 5B, and subsequently placed outside during use of the feeder, as shown in FIG. 5A. Adaptor 35 connects the feeding tube assembly to disk 46 in the same manner as shown in FIG. 7A. A center knockout aperture 51 can again be removed to provide access to feeding solution 15 through center bore 35a of the adaptor. However, in the first storage position of the hummingbird feeder, as shown in FIG. 5B. an alternate means can be provided to retain the feeding solution. A plug 48 having a tip 49 can be provided that threads into the modified cap. Threads 48a of the plug engage upper threads 48b of the modified cap and tip 49 fits into the center bore 35a of the adaptor. The plug is removed when the cap and disc are inverted to realize the second feeding position.

It is possible to add a locking mechanism between the bottom cap and the fluid reservoir to prohibit the removal of the inverted cap from the reservoir, as disclosed in the art. This is considered to be an added expense and is not necessary. Any bird loving user properly warned about the danger in contamination of the feeding solution by reusing the feeder will not reuse it. Label 12 (see FIG. 1) clearly includes this warning. The critical factor is to make the feeder a low cost feeder. If the user is determined to reuse the feeder, simply drilling a hole in the top will allow the user to refill the reservoir.

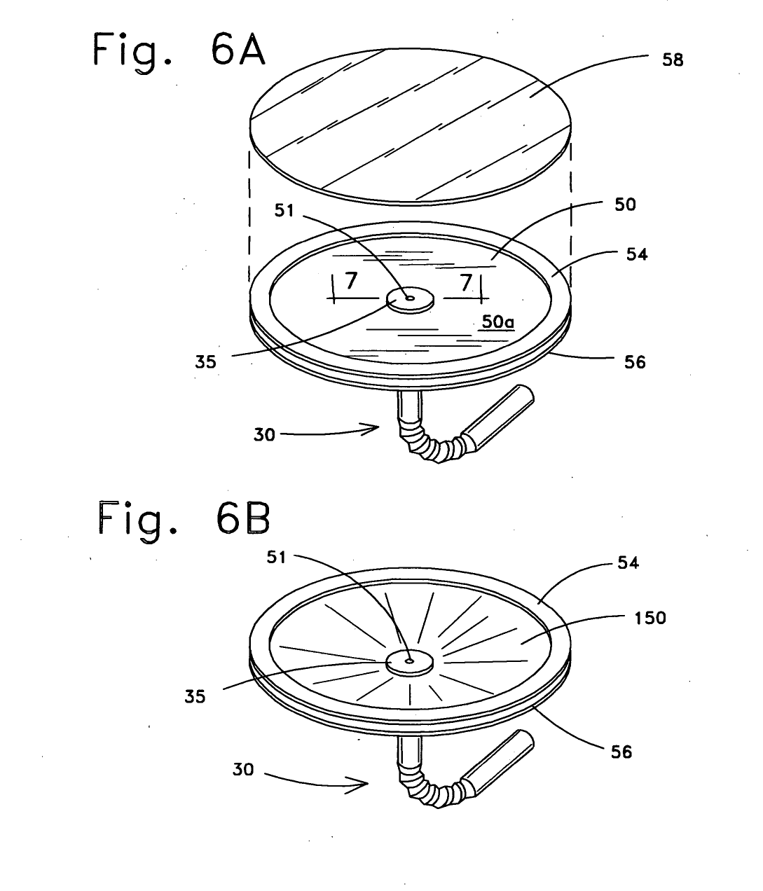

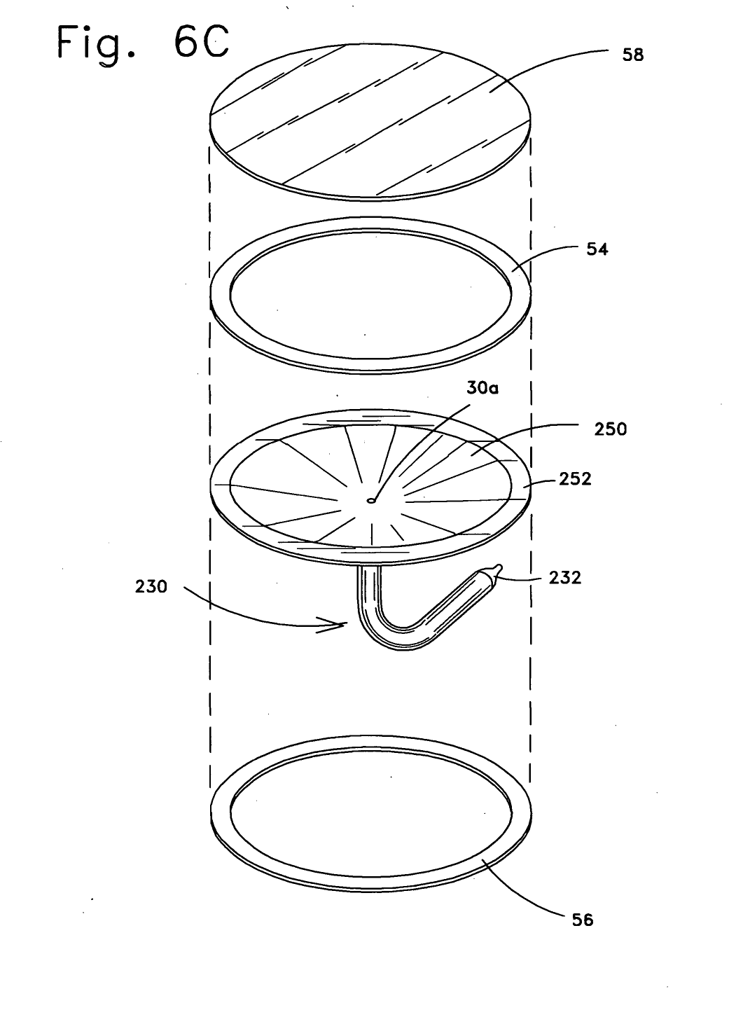

Further details and embodiments of the bottom disc in combination with the feeding tube assembly are illustrated in the perspective views of FIGS. 6A, 6B and 6C. An additional safety feature against feeding solution contamination is illustrated in FIG. 6A. A safety shield 58 is placed over the free surface of bottom disc 50, opposite the side having the feeding tube assembly. When the hummingbird feeder is in the first stored position of FIG. 5, the safety shield is on the bottom to protect the bottom surface from being contaminated. This surface is in contact with the feeding solution when the bottom disc and feeding tube assembly is reversed to that of FIG. 4; to achieve the second inverted feeding position. The safety shield can have a sticky surface to adhere to the bottom disc to be easily removed when the hummingbird feeder is placed into service. The views also illustrate the placement of first and second disc edge sealers 54 and 56 respectfully. Once again, tube adaptor 35 has a center knockout aperture 51 to be removed when the hummingbird feeder is placed into service.

The perspective view of FIG. 6B shows a bottom disc 150 in the shape of a cone. This preferred aspect of the invention allows the feeding solution in the fluid reservoir to empty more completely through center knockout aperture 51. The portion of conical bottom disk 150 to receive the first and second disc edge sealers should be made flat to maintain the seal between the conical bottom disc and the fluid reservoir. In another aspects of the invention an integral bottom disc 250 and a feeding tube assembly 230 can be made as an one part, as illustrates in FIG. 6C. First and second disc edge sealers 54 and 56 are, once again, placed on a flat portion 252 of the integral bottom disc. Safety shield 58 is provided with this other aspect to close center aperture 30a prior to placing the hummingbird feeder in service. The integral bottom disc can also be made flat as in FIG. 6A. A snip-off end 232 can be provided to gain access to the exit aperture.

An enlarged cross-sectional view of tube adaptor 35 penetrating bottom disc 50 is illustrated in FIG. 7. This view is taken along line 7-7 in FIG. 6A. Knockout portion 51 is in the center of the tube adaptor to be removed when the hummingbird feeder is placed in service. Main tube 32 of the feeding tube assembly is connected to the tube adaptor to support the feeding tube assembly. An adhesive can be used to seal the connection of the feeding tube assembly to the bottom disc. In an alternate aspect of the invention, tube adaptor 35 can be attached to the opposite side of bottom disc 50 from that shown using an adhesive. In yet another aspect, the bottom disc can be formed integrally with the tube adaptor. Other tube assembly attachment means common in the industry can also be used within the scope of the invention.

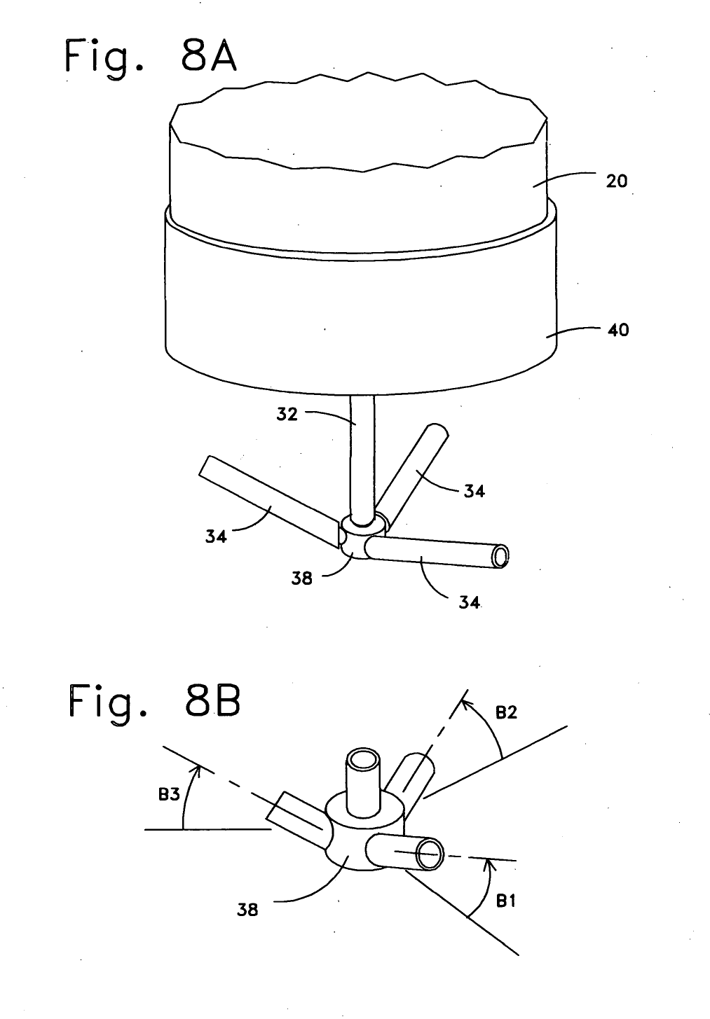

In one embodiment of the invention multiple exit tubes are used to provide a plurality of exit apertures. This embodiment is realized by providing an exit adaptor 38 between main tube 32 and the exit tubes 34, as illustrated in FIG. 8. Multiple feeding angles “B1-B3” are used to provide optimum access by the hovering hummingbird or hummingbirds. Feeding angles are measured from a horizontal plane. Generally speaking only one hummingbird feeds at a time. However, one hummingbird may prefer a different feeding angle than another hummingbird. Therefore, the feeding angles can be made to have different magnitudes. The preferred values range is from about thirty degrees to about fifty degrees.

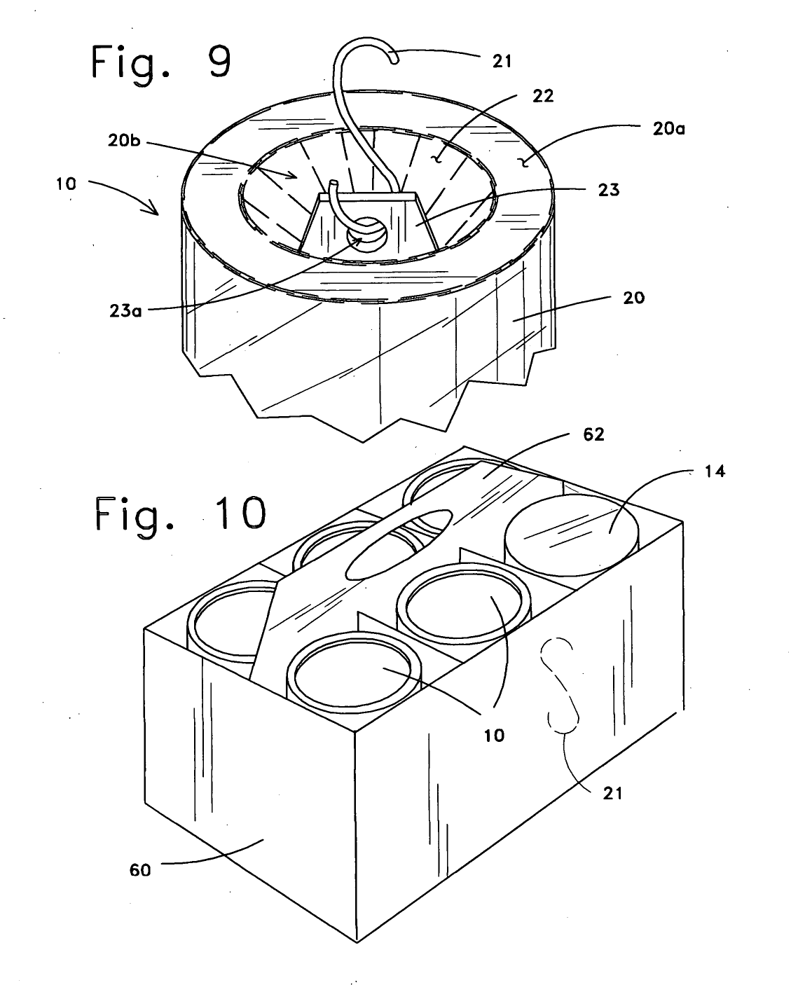

Details of the top portion of fluid reservoir 20 of the hummingbird feeder are illustrated in the perspective view of FIG. 9. Top surface 20a has recessed top 20b forming a moat 22 to receive the insect inhibiting fluid. A hangar tab 23 extends upward from the bottom of the mote. A hangar aperture 23a in the hangar tab receives hangar 21. The mote provides an effective barrier which prevents insects, and especially ants, from traveling down the hangar 21 to the feeding tube assembly. The mote is made so that the insect inhibiting fluid is made to completely surround the hangar tab.

The hummingbird feeder of this invention is to be marketed as a disposable unit. Therefore, a number of units are to be purchased at the same time so that the user can immediately replace a hummingbird feeder when the feeding solution in one unit has been consumed, or is no longer useful. The preferred packaging means is illustrated in FIG. 10. A carrying case 60 is provided which is very similar to a six-pack soft drink carton. The carrying case has space for six hummingbird feeders 10 to be carried by a handle 62. Within the scope of the invention, the hummingbird feeders can also be placed in an inverted position from that show. Alternately, a mote fluid container 14 can replace one of the hummingbird feeders to provide the insect inhibiting fluid to be placed in moat 22 when each unit is placed into service. A plastic shrink wrap is also acceptable for packaging a number of units.

The materials used for transparent cylindrical fluid reservoir 20 are preferably clear plastic or glass. The transparent feature of these materials allows the user to gage the amount of feeding solution 15 remaining in the fluid reservoir before the hummingbird feeder is replaced. The fluid reservoir is specifically designed to prevent spoilage by making the fluid reservoir small to provide only a few days supply of the feeding solution. Spoilage can cause intestinal problems for the hummingbirds. The preferred capacity is about one-half pint.

The preferred feeding solution 15 is a sugar solution, generally called a nectar. A critical problem exists when the nectar spoils resulting in the health of the hummingbird being endangered. Physical changes in the feeding solution occur with spoilage; such as changes in acid content, specific gravity, presence of alcohol, presence of bacteria and the like. These changes can be used to remove the feeder when necessary. A need exists to have a visual means to indicate at least one of these physical changes. Preferably an additive is placed in the fluid reservoir which changes in appearance to indicate spoilage of the feeding solution. The additive can be in the form of either a coating on the interior of the reservoir or a floating object that informs the user that the feeding solution has spoiled. The additive produces a change in the appearance when said feeding solution is no longer safe for consumption by the hummingbird. The additive may also be a chemical additive added to the feeding solution which changes the appearance of the solution by causing a color or clarity change due to spoilage. The floating additive may be a pill that changes in color when the feeding solution spoils. A sterile feeding solution is added to fluid reservoir 20 prior to the point-of-sale to provide the best protection against contamination by the user. The safety shield 58 (FIG. 6C) is a plastic material also provided to guard against contamination.

Insect inhibiting fluid 24 added to mote 22 of the recessed top 20b (see FIG. 9) is preferably a non-toxic mineral oil or gel. The oil provides an effective barrier which prevents insects, and especially ants, from traveling down the hangar 21 to the feeding tube assembly and the feeding solution. The insect inhibiting fluid may also comprise some form of insecticide or agent or water treated with a wetting agent such as a soap.

The material used for bottom cap 40 is preferably a plastic material. Other materials, such as a metal or wood, can also be used for the bottom cap within the scope of this invention. The bottom cap has threads which mesh with the threads of the fluid reservoir so that a proper seal can be formed by making tight the bottom cap on the fluid reservoir. First and second disc edge sealers 54 and 56 are preferably made of a soft rubber material. The bottom cap is made red to attract the hummingbird.

The material used for feeding tube assembly 30 can be a rubber or plastic tube material. Preferably a plastic material is used so that tube flex portion 32 can be deformed to achieve the optimum feeding angle for the hummingbird. Tube adaptor 35 and exit adaptor 38 are preferably formed from a plastic material. The feeding tube assembly is made red to attract the hummingbirds.

While a preferred embodiment of the invention has been described using specific terms an a particular prior art reference, such description is for illustrative purposes only, and it is to be understood that changes and variations may be made without departing from the spirit or scope of the following claims. The foregoing is considered to be illustrative only of the principles of the invention. Since numerous modifications and changes will readily occur to those skilled in the art, it is not desirable to limit the invention to the exact construction and operation shown and described. Accordingly, all suitable modifications and equivalents may be resorted to, falling within the scope of this invention. All equivalent relationships to those illustrated in the drawings and described in the specifications are intended to be encompassed by the present invention.

What is claimed is:

1. A disposable hummingbird feeder comprising:
a transparent fluid reservoir filled with a feeding solution and having a closed and recessed top and an open cylindrical bottom portion with threads;
a bottom cap having cap threads that mesh with said threads of the fluid reservoir;
a bottom disc carried by said bottom cap to be friction sealed against a bottom edge of said fluid reservoir to help retain said feeding solution; and
a feeding tube assembly connected to a center of said bottom disc to provide an exit aperture for the hummingbird to access said feeding solution, wherein said bottom disk and feeding tube assembly have a first sealed storage position where said feeding tube assembly extends upward into said fluid reservoir and a second inverted feeding position where said feeding tube assembly extends downward to be accessed by the hummingbird; and
said feeding tube assembly includes at least one exit tube which is rotationally adjustable both vertically and horizontally for optimum access by the hummingbird to said exit aperture and for viewing.

2. The hummingbird feeder of claim 1 wherein said feeding tube assembly further comprises a tube adaptor for connecting a main tube to said bottom disc to extend downward from said bottom disc to a tube flex portion connected to said exit tube.

3. The hummingbird feeder of claim 2 wherein said flex tube portion provides said vertical rotation of said exit tube for the hummingbird to have an optimum hovering angle when accessing said exit aperture and wherein said disc and feeding tube assembly are rotated about a vertical axis with respect to the fluid reservoir for optimum horizontal access to said exit aperture by the hummingbird.

4. The hummingbird feeder of claim 2 wherein said tube adaptor has a center knockout aperture to allow said feeding solution to flow into said feeding tube assembly when the second inverted feeding position is realized to initiate use of the feeder.

5. The hummingbird feeder of claim 1 wherein said first sealed storage position has a first disc edge sealer located between said bottom disc and said bottom edge of said fluid reservoir and a second disc edge sealer located between said bottom disc and said bottom cap and wherein the second inverted feeding position has said first disc edge sealer located between said bottom disc and said bottom cap and said second disc edge sealer located between said bottom disc and said bottom edge of said fluid reservoir.

6. The hummingbird feeder of claim 1 wherein said feeding tube assembly is made integral with said bottom disc and includes a snip-off end to access said exit aperture.

7. The hummingbird feeder of claim 1 wherein a modified bottom cap is made integral with a modified bottom disc and includes upper and lower threads so that said modified bottom cap and disk are both inverted, along with said feeding tube assembly, to convert the feeder from said first storage position to said second inverted feeding position.

8. The hummingbird feeder of claim 1 wherein said recessed top portion of said reservoir includes a hangar tab with an aperture to receive a hangar to hang the hummingbird feeder in an optimum location.

9. The hummingbird feeder of claim 8 wherein said recessed top portion provides a moat to receive an insect inhibiting fluid to form a barrier against insects reaching said feeding solution.

10. The hummingbird feeder of claim 1 including an additive in the form of one or either a coating on the interior of the reservoir or a floating object that informs the user that the feeding solution has spoiled, wherein said additive produces a change in appearance and either one of a physical or chemical composition when said feeding solution is no longer safe for consumption by the hummingbird.

11. The hummingbird feeder of claim 1 wherein said fluid reservoir has a capacity of about eight liquid ounces (one-half pint or 275 ml) for providing safety by limiting its usable lifespan.

12. The hummingbird feeder of claim 1 wherein said feeding tube assembly includes a tube adaptor for connecting a main tube to said bottom disc, at least one exit tube and an exit adaptor for connecting said main tube to said at least one exit tube.

13. The hummingbird feeder of claim 12 wherein said feeding tube assembly includes three exit tubes providing three exit apertures, wherein the three exit tubes are rotationally adjusted at different feeding angles above a horizontal plane.

14. The hummingbird feeder of claim 1 further comprising:
a thin removable safety shield placed over a lower surface of said bottom disc when said disc and feeding tube assembly are in the first sealed storage position, so that the feeding solution is not contaminated when the second inverted feeding position is realized.

15. A disposable hummingbird feeder assembly comprising:
a transparent cylindrical reservoir filled with a feeding solution and having a closed top portion with a recess and an open bottom portion with a bottom edge, wherein said recess forms a moat with a hangar tab for a hangar and said bottom portion has threads;
a bottom disc supported by a bottom cap threaded to said reservoir to help retain said feeding solution within said reservoir;
a feeding tube assembly connected to said bottom disc using a tube adaptor to provide an exit aperture for the hummingbird to access said feeding solution, wherein said bottom disk and said feeding tube assembly have a first sealed storage position where said feeding tube assembly extends upward into the fluid reservoir and a second inverted feeding position where said feeding tube assembly extends downward to be accessed by the hummingbird.

16. The hummingbird feeder assembly of claim 15 wherein said bottom disc is supported and sealed against said bottom edge of said fluid reservoir by an annular flange of said bottom cap, wherein first and second disc edge sealers provide the seal during both said first storage position and said second inverted feeding position of said bottom disc and said feeding tube assembly.

17. The hummingbird feeder assembly of claim 16 further comprising:
a removable thin safety shield placed over a lower surface of said bottom disc when said disc and feeding tube assembly are in said first sealed storage position, so that said feeding solution is not contaminated when said second inverted feeding position is realized.

18. The hummingbird feeder assembly of claim 15 wherein said feeding tube assembly includes a main tube connected to said tube adaptor and at least one adjustable exit tube providing at least one exit aperture.

19. The hummingbird feeder assembly of claim 15 wherein said feeding solution includes an additive that produces a change in the appearance and chemical composition of the feeding solution when it is no longer safe for consumption by the hummingbird.

20. The hummingbird feeder assembly of claim 15 wherein said cylindrical reservoir has a red label applied thereto having general logo, use and safety information printed thereon.
